(19) United States
(12) Patent Application Publication
(10) Pub. No.: US 2023/0265914 A1
(43) Pub. Date: Aug. 24, 2023

(54) VARIABLE DIAMETER SHAFT CONTINUOULSLY VARIABLE TRANSMISSION (VDS.CVT)

(71) Applicant: Alireza Rostamlou, Fardis (IR)

(72) Inventors: Alireza Rostamlou, Fardis (IR); Arash Rostamlou, Fardis (IR)

(21) Appl. No.: 17/648,158

(22) PCT Filed: Jul. 23, 2019
(86) PCT No.: PCT/IB2019/056281

§ 371 Date: Jan. 17, 2022

(51) Int. Cl. F16H 9/10; F16H 37/02; F16H 55/54

(52) U.S. Cl. CPC F16H 9/10; F16H 37/022; F16H 55/54

(57) ABSTRACT

The (VDS·CVT) is a continuously variable transmission. This mechanism consists of two sets variable diameter shaft, one sun gear set. On each shaft sets are mounted a number of the guide rods on shafts, some movable sets that any of them placed on each pair guide rods, two guide disks with some curve grooves on surface, by rotation of disks, the diameters of shaft will be changes. Variation's diameters in two shaft sets are Continuous. The variations ratio of the rotational speed between two shaft sets are continuous. Secondary shaft connected with one components of sun gear set, and second component of sun gear set connected with input shaft and third component of sun gear set connected with output shaft. Because the variations of the rotational speed on the secondary shaft is continuous, the variations of the rotational speed on the output shaft will be continuously.

### CROSS REFERENCE TO RELATED APPLICATION

This application claims the benefit of priority to PCT/2019/056281 filed on Jul. 23, 2019, all of which are incorporated by reference herein in their entireties.

### TECHNICAL FIELD

The present application relates generally to transmissions, and more particularly, to a variable diameter shaft continuously variable transmission (VDS. CVT) for producing high torque output, high power transmission and efficiency of the transmission.

### BACKGROUND

Transmissions are used in transportation, agricultural and construction equipment to transmit power from power sources, such as internal combustion engines to equipment for accomplishing a desired task. For example, transmissions are used to properly transmit power to the wheels of a vehicle, or to a vehicle implement. Various industries use gear mechanisms for transmission and conversion of engine power. Continuously variable transmission (CVT) can be used to overcome the above mentioned disadvantages of gearboxes. A continuously variable transmission (CVT) is a transmission that can change through an infinite number of effective gear ratios between a minimum and a maximum range. In contrast, non-CVT transmissions offer a fixed number of gear ratios. Specifically, hydrostatic CVTs may use a variable displacement pump and a hydraulic motor and transmit power using hydraulic fluid. A swash plate may be used within the variable displacement pump to vary the output of the hydrostatic CVT by adjusting the fluid flowing into the hydraulic motor. Thus, the swash plate may enable the hydrostatic CVT to be continuously variable. Some hydrostatic CVTs may be combined with gear assemblies, drive shafts, and clutches to create a hydro-mechanical CVT. It may be appreciated that in certain applications, such as in construction equipment, a high torque output may be utilized by implements of the construction equipment. Further, a high torque output may be beneficial for low speed movement of vehicles, such as construction vehicles or agricultural vehicles.

In CVTs, transmission rate between an input shaft and an output shaft can be changed continuously in a linear manner such that infinite number of transmission rates is available between predefined lower and upper limits. In a CVT, transmission is provided by friction between parts of the CVT. in this mechanism the highest power is transmitted through hydraulic fluid. For example, in a belt driven CVT, friction between a belt and a pulley and in a toroidal CVT, friction between a toroid and disks of the CVT cause the transmission. In the both mechanisms, the friction between driver and driven and also between V belt and pulley is very low.

However, using the friction mechanism in CVTs cause problems such as limited transmission capability, high depreciation, low efficiency, and lack of stability in the selected revolution. Hence there is a need for a VDS. CVT to produce efficient transmission with continuous/linear variation and high friction surface and high torque output and high-power transmission.

### SUMMARY

The disclosed subject matter relates to a variable diameter shaft continuously variable transmission (VDP·CVT) This invention is based on the power transfer (torque-rotation speed) from the input shaft set to the output shaft by an endless flat belt and a secondary shaft set and a set of sun gear. One part of sun gear set connected with input shaft set and second part of sun gear set connected with secondary shaft set and third part of sun gear set connected with output shaft. Devised sets of main and secondary movable parts on the circumference of the input shaft and secondary shaft, by moving those movable parts on the main and secondary guide rods and along the radii of the input and output shafts. The diameter sizes of the shaft changes, and with the change in the diameters size of the input shaft set and second shaft set, the conversion ratio of rotation speed between of the two input and secondary shafts changes. Because the diameter changes in the shaft sets are continuously, therefor the changes in the rotation speed conversion ratio between the of rotation speed between the input shaft set and secondary shafts will be continuous. Because one part of sun gear set is connected with input shaft and second part of sun gear set connected with secondary shaft set and third part of sun gear set connected with output shaft, therefor the changes in the rotation speed conversion ratio between input shaft and output shaft will be continuous. In this mechanism, can achieve from negative ratio of rotation to positive ratio of rotation.

### BRIEF DESCRIPTION OF THE DRAWINGS

Devised sets of main and secondary movable parts on the circumference of the input shaft and secondary shaft, by moving those movable parts on the main and secondary guide rods and along the radii of the input and output shafts. The diameter sizes of the shaft changes, and with the change in the diameters size of the input shaft set and second shaft set, the conversion ratio of rotation speed between of the two input and secondary shafts changes. There are some plate parts placed on the main movable sets, the duty of these plate parts is to cover the distance between the two adjacent sets of movable sets. Six mechanisms are used to control the movement of main and secondary movable sets as follows.

The first control mechanism has a number of the main guide rods that are mounted on the environments of the input and output shafts and in radii direction of input and output shafts. Each main movable set (with cover plate parts) placed on each pair of main guide rods and these movable sets have liner motion on the main guide rods.

The second control mechanism has a number of the secondary guide rods that are mounted on the input and output shafts and in radii direction of input and output shafts and have. Each secondary movable set placed on each pair of secondary guide rods and have liner motion on the secondary guide rods, the duty of secondary movable set is to control the motion of the cover plates that installed in the main movable set.

The explanation is that, curve groove direction on the surfaces of pair disks is placed on the input or output shafts, they are symmetrical and when assembled they will have the same direction of grooves. Has been created a hole at the center of each of the disks and also two other holes at the specified points for coupling two guide disks to each other and four holes for mounted two interface sets (on a disk of each pair disk).

The third control mechanism is two guide disks for each of the input and output shafts, on the surface of each guide disks, has been created a number of tow kind curve grooves (or linear) and the number of each kind (first kind and second kind) of grooves are equal with the number of main movable sets or number of secondary movable sets.

The explanation is that, curve groove direction on the surfaces of pair disks is placed on the input or output shafts, they are symmetrical and when assembled they will have the same direction of grooves. Has been created a hole at the center of each of the disks and also two other holes at the specified points for coupling two guide disks to each other and four holes for mounted two interface sets (on a disk of each pair disk).

Two interface sets are mounted on one of a pair disk. Two disks are placed on each shaft (input and secondary) so that one of them placed on left side of the pairs of guide rod and other of them placed on the right side of the pairs of guide rod and also the groove surfaces of the disks are aligned. Each pair of disks are placed on their input and secondary shafts can have a rotary motion relative to their shaft.

In each shaft, one end of the main movable set is placed into the one first kind curve (or linear) groove of a disk that placed on left side of guide rod pairs and other end of the main movable set is placed into the one first kind curve (or linear) groove of a disk that placed on right side of guide rod pairs.

Also in each shaft, one end of the secondary movable set is placed into the one second kind curve (or linear) groove of a disk that placed on left side of guide rod pairs and other end of the secondary movable set is placed into the one second kind curve (or linear) groove of a disk that placed on right side of guide rod pairs.

All the ends of the main movable sets and all the ends of the secondary movable sets in this way are placed in the next curve grooves. Two interface sets for each pair of guide disks, mounted on the one of the guide disks (on the side that has not grooves). One pair guide disk that placed on each shaft (input and secondary) coupled together by two small shafts.

The main guide rods which are mounted on the shafts (input and secondary) with curve grooves (first kind) on the disk surfaces, control the place position of the main movable sets (each pair main guide rods with two first kind curve grooves from two face to face disks, they control a main movable set).

The secondary guide rods which are mounted on the shafts (input and secondary) with two curve grooves (second kind) on the disk surfaces, control the place position of the secondary movable sets (each pair of secondary guide rods with two second kind curve grooves from tow face to face disks, they control a secondary movable set).

By displacement of the main movable sets on the main guide rods and secondary movable sets on the secondary guide rods, diameters sizes of two shafts will be changed (input and secondary), by this method, the diameters of the shaft sets can be changed and variable diameters on input and secondary shaft sets will be achieved. The secondary movable sets help to control the cover plates that placed on the main movable set.

The fourth mechanism is a slider set for each input and secondary shaft. Each slider set consists of a cylindrical slider part and a bearing and a retainer part. The cylindrical part has a hole in the axis and in direction of length and has groove on the inner surface of the hole and also two helical and symmetrical grooves on the outer surface of the cylindrical, each of these two cylindrical parts is connected to a retaining part through a bearing.

These set of sliders are placed on the input and secondary shafts in some way the place of the inside groove of the hole is fitted to the parallel key that mounted on the input and output shafts (the rotational speed of the cylindrical part is same with his shaft). In each shaft (input and secondary) two small shafts of two interface sets (two interface sets are mounted on the guide disk) are placed inside the two outer helical grooves of the cylindrical part.

These cylindrical slider sets can have liner motion on the shafts (Input and secondary) in axis direction. With linear motion of cylindrical slider sets on the shafts and in the direction of the axis of the shafts (input and secondary), causing, rotation the pair of guide disks relative to their shafts, and this rotation of the disks causing the regular movement of movable sets (main and secondary) on their guide rods in direction of their guide rods axis.

In this way, the variable diameters of input and secondary shafts will be changed. As previously explained, because the direction of curved grooves of guide disks of the input shaft is different with direction of curved grooves of guide disks of the output shaft. Therefore, by moving both cylindrical slider sets in one direction (forward or backward), the variation in the diameters of the two input and secondary shafts will be inverse.

The fifth control mechanism is a mover mechanism for moving cylindrical slider sets, mover mechanism consisting of an actuator (mechanical, electrical, hydraulic, etc.), a connector plate, two guide shafts for connector plate.

The sixth control mechanism is first part of sun gear set connected with input shaft 2 and second part of it connected with secondary shaft set 21 and the third part of it connected with output part 30, for example, carrier is fixed with input shaft 2, ring gear involved with secondary shaft set 21 by three interface gears and sun gear fixed on output shaft.

In this mechanism, in order to further increase of the friction between the main movable sets and the carrier belt, it results in better efficiency, is used one incremental set.

With the sets and parts described, the invention is completed. Since the movement created by the actuator (mechanical, electrical, hydraulic) is continuous, the movement of the cylindrical slider sets will be also continuous and follow it, the rotation of the pair guide disk and the diameters changes will be continuous. As a result, changes in the conversion rate (output to input) will be continuous.

FIGS. 1-17 illustrate components of an exemplary variable diameter shaft continuously variable transmission (VDS. CVT).

### DETAILED DESCRIPTION

As indicated above, the parts and sets that installed and assemblies on the two input shaft set 2 and secondary shaft set 21 are same, but the direction curve grooves of guide disks are different (they are inversely in the direction of the curve grooves in the corresponding disks). Therefore, to avoid repeating the threads, only one shaft sets is described, for example the input shaft set is described.

And for a better understanding of the mechanism, for the components and assemblies 3, 4, 5, 6 that they can be selected numerous, we select a certain number, for example, for each of the input and output shaft set, twenty-four numbers of main guide rods 3 and twelve sets of main movable 6 and the twenty-four numbers secondary guide rods 4 and twelve sets of secondary movable 5 are selected.

For more clarity and better depicting the performance of the parts in most figures, instead of showing all of the twenty-four numbers main guide rods and twelve sets main movable, only four numbers main guide rods and two sets main movable are shown.

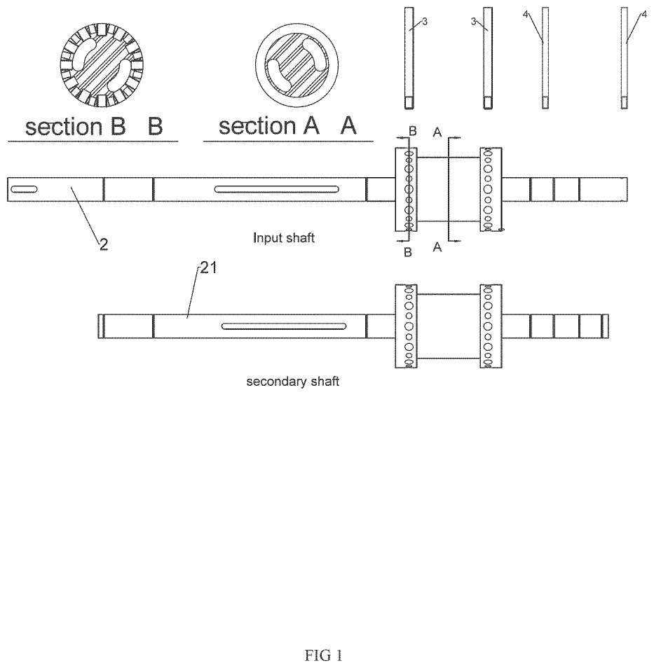

FIG. 1 the input shaft 2 and the secondary shaft 21, as explained, here only the input shaft is described. On the input shaft 2, two grooves for parallel keys and forty-eight holes are formed so that the axis of holes are in the direction of the shaft radii and under an angle of fifteen degrees (Section B-B), twenty-four numbers of these holes (big size) for the main guide rods 3 are considered (The two-row holes are one-to-one along the axis of the shaft).

And twenty-four numbers other holes (small size) for the secondary guide rods 4 are considered (the two-row holes are one-to-one along the axis of the shaft). A pair of main guide rods 3 and a pair of secondary guide rods 4 are shown on the figure. There are also two symmetrical holes (inside a part of the shaft having a larger diameter) and created along the shaft axis (section A-A).

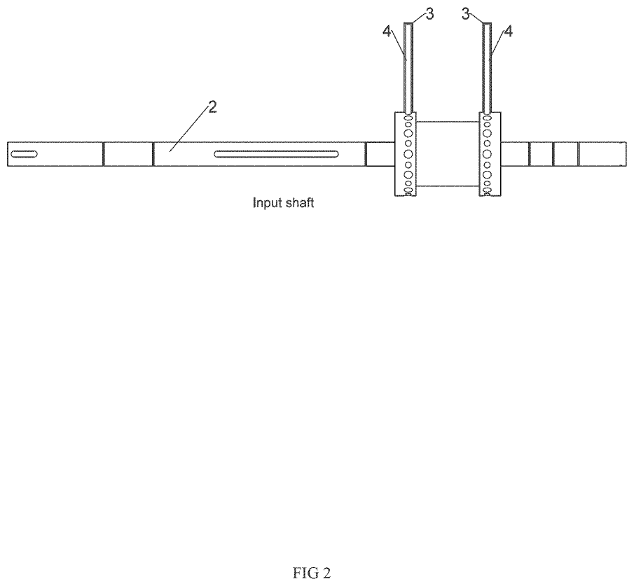

FIG. 2 one pair of main guide rod 3 and one pair of secondary guide rod 4 are showing on the input shaft 2.

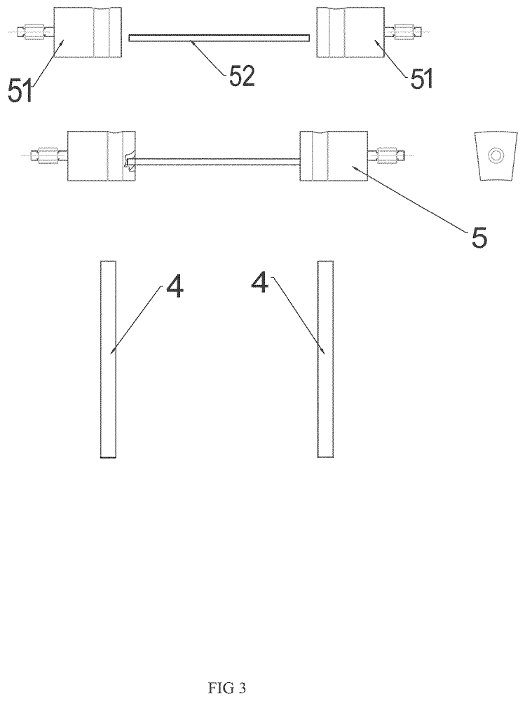

FIG. 3 the secondary movable sets 5 is composed of:
A) Two parts 51 having holes of equal diameter (with a further tolerance) with diameter of secondary guide rod 4, and on one side of each these parts 51 is fitted a small shaft, these small shafts will be placed in the curve grooves (second kind) of the guide disks; and
B) A shaft 52 arranged between two parts 51 that fixes these two parts in such a manner that the axial distance of the two holes of two parts 51 is same with the axial distance of the two secondary guide rods 4, which will be placed on the input shaft, as shown in the figure, the two secondary guide rods 4 will be placed within the holes of the set 5, and the set 5 can linear motion along of a pair guide rods 4 axes.

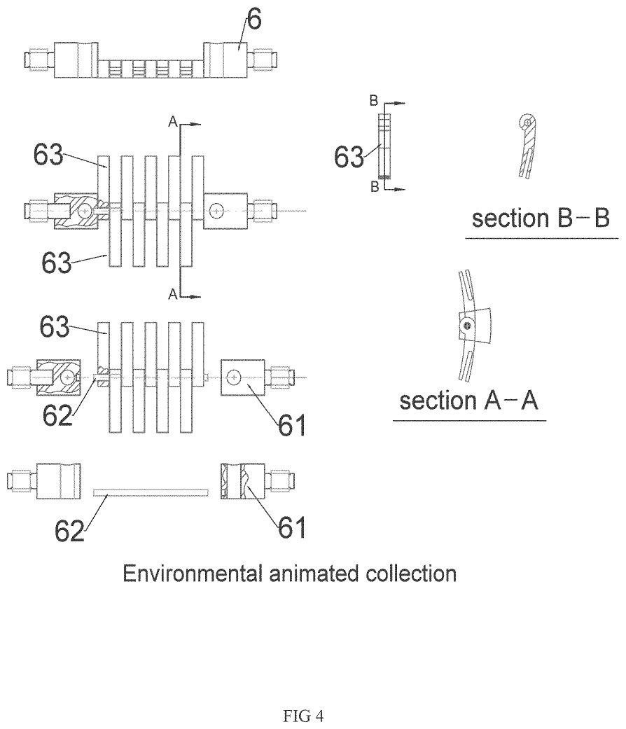

FIG. 4 the main movable sets 6 is composed of:

A) Two parts 61 having holes of equal diameter (with a further tolerance) with diameter of main guide rod 4, and on one side of each these parts 61 is fitted a small shaft, these small shafts will be placed in the curve grooves (first kind) of the guide disks;
B) Nine numbers (or more) of cover plates 63 these have hole and that are placed on the shaft 62 in the free mode, the outer surface of the part 63 in the form of a section of the environment of the circle, radius of the circle is the same size of the largest variable diameter of the input shaft and secondary shaft. Inside of the cover plates is formed a special curve groove; and
C) A shaft 62 with nine numbers of cover plates 63, arranged between two parts 62 that fixes these two parts in such a manner that the axial distance of the two holes of two parts 62 is same with the axial distance of the two guide rods 3, which will be placed on the input shaft, as shown in the figure, the two guide rods 3 will be placed within the holes of the set 6, and the set 6 can have linear motion along the axis on a pair guide rods 3.

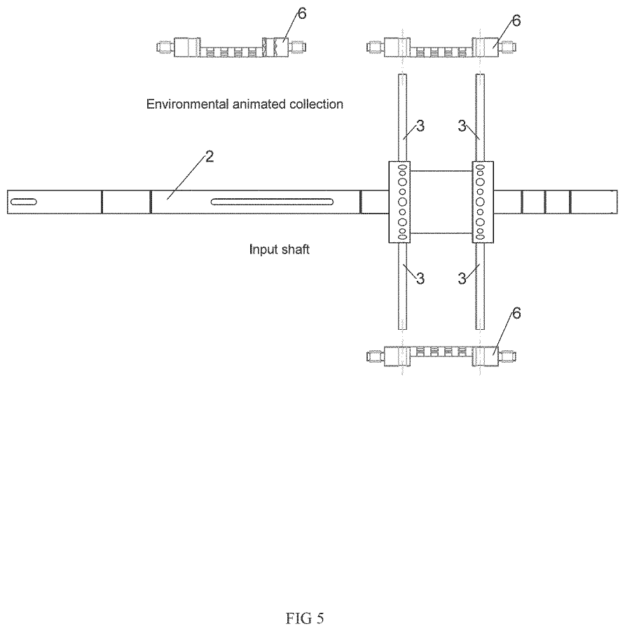

FIG. 5 two pairs of main guide rods 3 are shown, fixated in the holes on the input shaft 2, and two main movable sets 6 are shown.

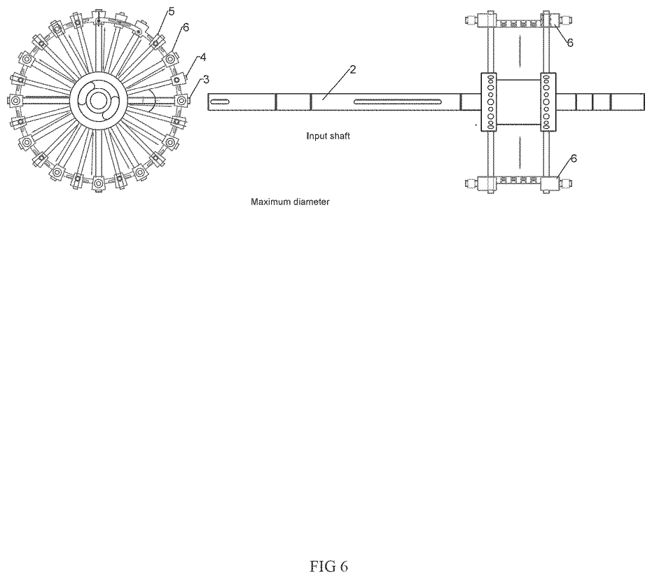

FIG. 6 on the right, the arrangement of the two main movable sets 6 is shown on two pairs of main guide rods 3 and these sets 6 can be linear motion along the axes of the two main rods 3 which in fact are in line The radii of the output shaft 2 and on the left said of the figure, as shown, how to place twelve sets of main movable 6 on twelve pairs of main guide rods 3 as well as how to place twelve sets of secondary movable 5 on twelve pairs of secondary guide rods 4.

This is the maximum diameter of the input shaft 2. As can be seen, two adjacent sets of cover plates 63 overlap each other, The shaft 52 from set 5 is placed inside the curved grooves in the cover plats 63 from two adjacent sets 6 and duty of shaft 52 is maintaining and matching the outer arc centers of the covering parts 63 belongs to the two adjacent sets 6. (Next, the circle created from main movable sets 6 will be variable diameter of the input shaft and secondary shaft).

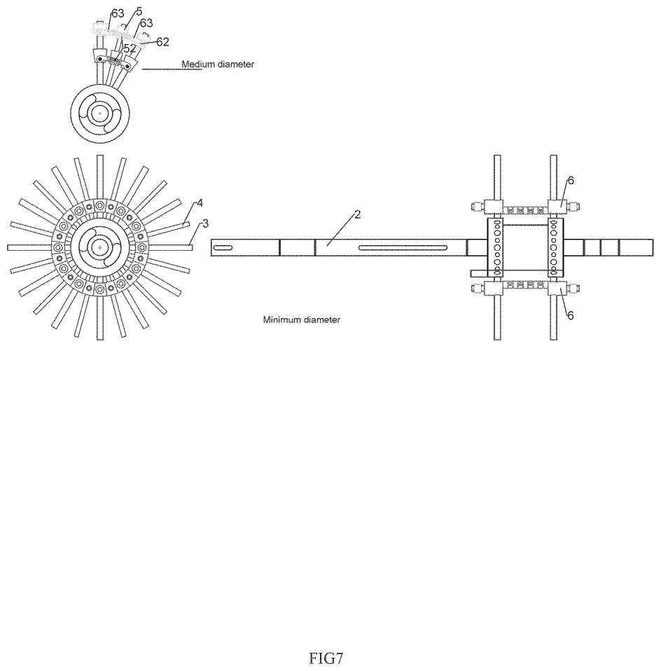

FIG. 7 on the right of figure, moving the two main movable sets 6 on the two pairs of main guide rods 3 towards the center of input shaft 2 and on the left of the figure, as shown how to place twelve main movable sets 6 on Twelve pairs of main guide rods 3 as well as how to place Twelve sets secondary movable 5 on Twelve pairs of secondary guide rods 4 and this is minimum diameter position is created.

On the top of this figure, in the medium diameter, the interaction between the two cover parts 63 and the shaft function 52 in maintaining the center of the arcs of the outer surface can be seen, which means that the two external arcs of the cover parts 63 from two adjacent main movable sets 6 will be matches together, and this will continue in all of the diameters.

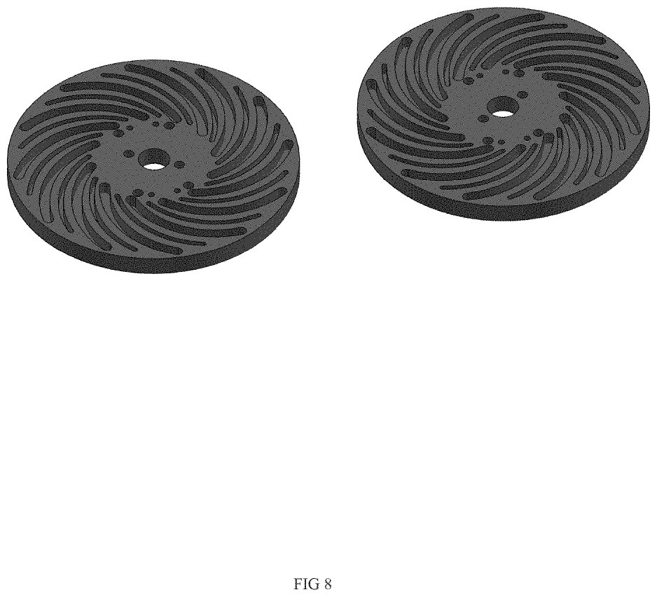

FIG. 8 3D Map of the two guide disks 7, each guide disk has a hole in its center and the diameter of this hole is equal to the diameter of the main shaft (with more tolerance), and two holes for coupling a pair click together and one of them has four holes for mounting the two interface sets (10, 9). There are twenty-four curve grooves on the surfaces of each disk.

The twelve curve grooves (first kind) for the main movable sets 6 and the twelve curve grooves (second kind) for the secondary movable sets 5, the width of the curve grooves of the secondary movable sets 5 is less than the width of the curve grooves of the main movable sets 6. It needs to be explained that the direction of the curve grooves in the two disks on the one shaft is not a same direction, but when the assembling two guide disks on the input or output shafts, direction of curve grooves of two disks will be the same direction.

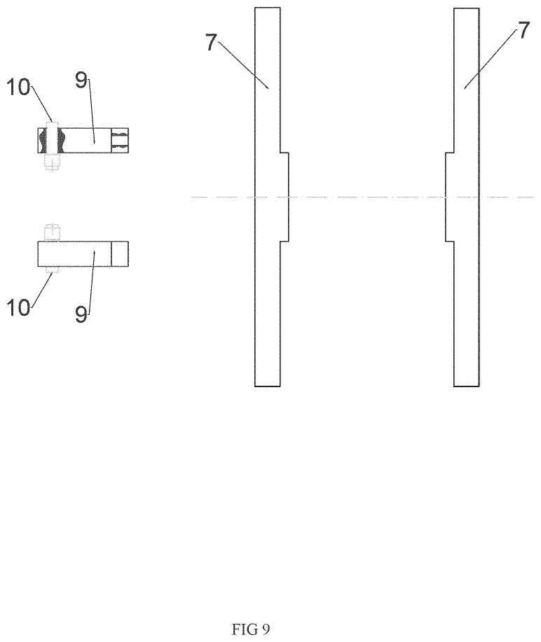

FIG. 9 a pair of guide disks are shown, which are placed on the input shaft, and also two parts 9 which a shaft 10 is mounted on each one of them, will be installed symmetrically on the left hand of guide disk.

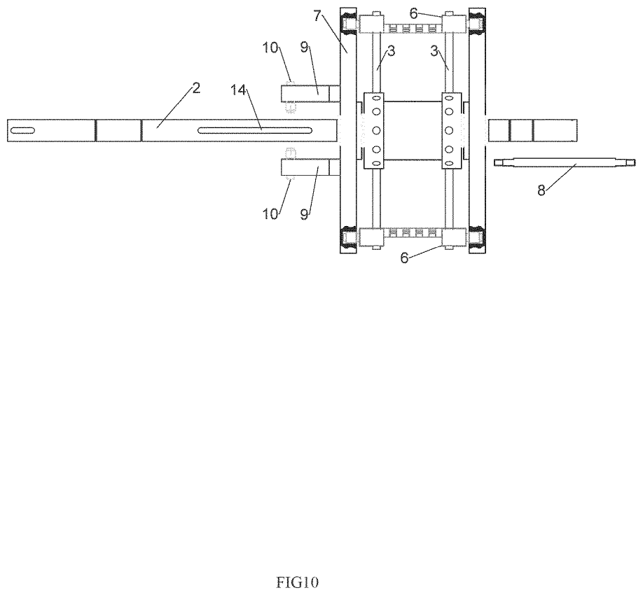

FIG. 10 two guide disks 7 are placed on the input shaft 2 So that one of the guide disks 7 with two interface sets 9,10 is on the left hand of the guide rods (3 and 4) and the second guide disk on the right of the guide rods (3 and 4) and they can rotate in relative to the input shaft 2, and the two guide disks are coupled together by two small shaft 8, and one parallel key 14 is placed on the output shaft 2.

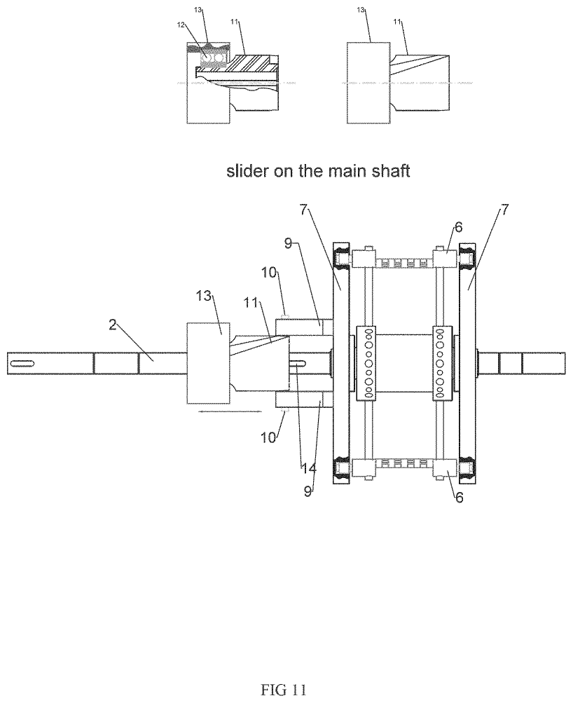

FIG. 11 as shown in this figure, there is a cylindrical slider set with parts (11, 12, and 13) and the cylindrical slider part 11 is connected by bearing 12 to retainer part 13. The part 11 has an inner hole and the diameter of the hole is equal to the diameter of the input shaft 2 (with further tolerance) and has one groove in side surface of the hole in direction of the hole axis for parallel key 14 and also has two helical and symmetrical guide grooves on the outer surface.

This cylindrical slider set 11,12,13 is somehow placed on the shaft 2, inner groove of the part 11 fitted to the parallel key 14 that is mounted on the shaft 2, and two shafts 10 that is mounted on two parts 9, is placed inside of two helical grooves of cylindrical slider part 11, the cylindrical slider 11 has a rotational speed equal to the shaft 2 rotational speed. Cylindrical slider 11 can have a linear motion along the input shaft 2 axis.

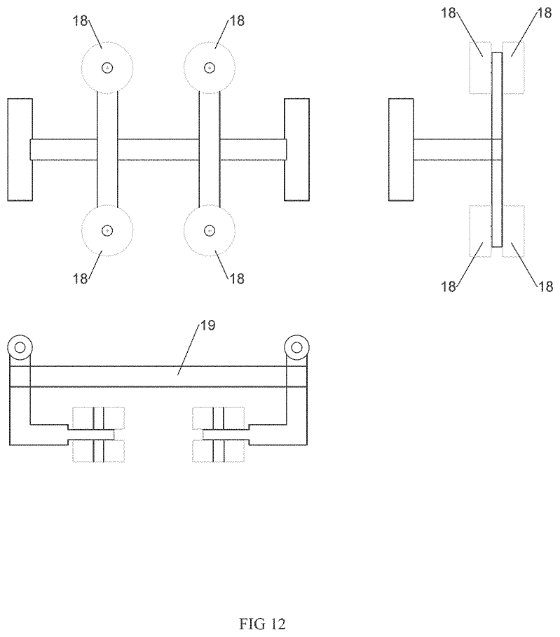

FIG. 12 an extension of the surface of the friction belt with the main movable sets 6 is composed of:
A) Two number guide shafts 18;
B) One number free-wheel drive retaining structures 19, capable of linear motion in direction of the two shafts 18 axis; and
C) Eight number round wheels 20.

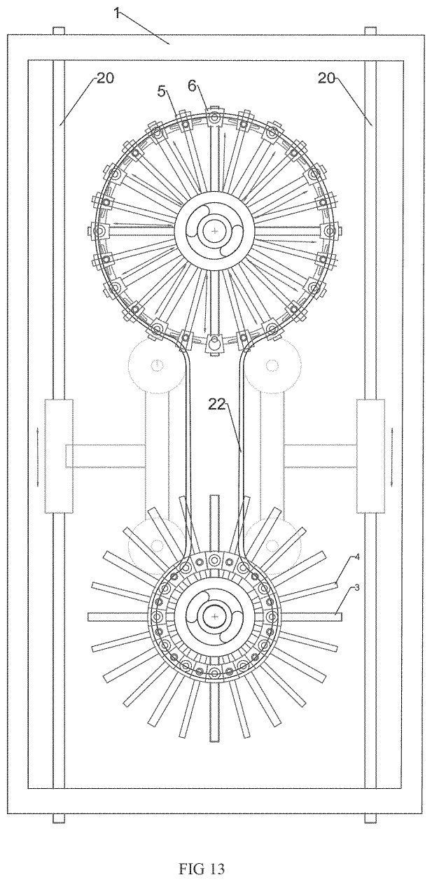

FIG. 13 in this figure, the position of the shafts 18 on the main body, as well as the arrangement of the retaining wheels 19 on the two shafts 18 and the contact of the eight wheels 20 with the endless flat belt 22, and one shaft set is in the maximum diameter and other shaft set is in the minimum diameter.

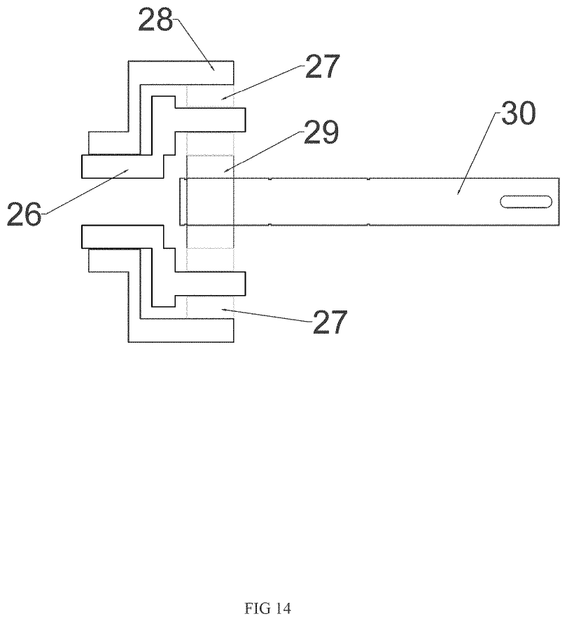

FIG. 14 one sun gear set consisting of parts, carrier (e.g., planetary carrier) 26, planetary gears 27, ring gear 28, sun gear 29. Carrier 26 fixed on input shaft 2, ring gear 28 placed on the Carrier 26 and the ring gear has free rotation on the Carrier, sun gear 29 fixed on the outer shaft 30.

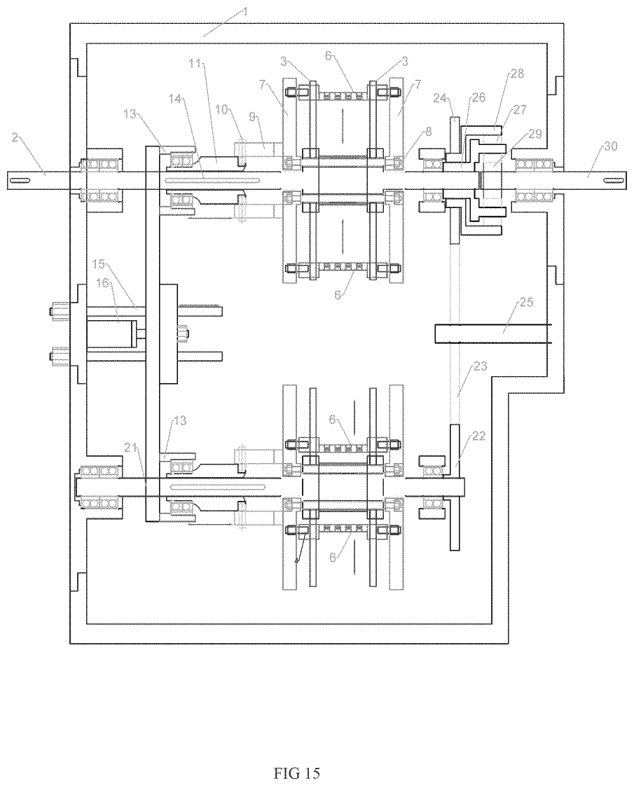

FIG. 15 configuration of mechanism and components includes:
A) One number main body 1;
B) Three numbers shaft, power input shaft 2, and secondary shaft 21;
C) Forty-eight numbers main guide rod 3, (Twenty-four numbers for each main shaft);
D) Forty-eight numbers secondary guide rod 4, (Twenty-four numbers for each main shaft);
E) Twenty-four sets secondary movable 5 consisting of parts 51,52, (Twelve sets for each main shaft);
F) Twenty-four sets main movable 6 consisting of parts 61, 62, 63, (Twelve sets for each main shaft);
G) Four numbers guide disk 7, (Two guide disks for each main shaft);
H) Four numbers shaft 8 for coupling disks (two shafts for coupling two disks);
I) Four sets of interfaces consisting of parts 9, 10, (two sets for each main shaft);
J) Two sets of cylindrical sliders that consisting of parts 11, 12, 13, (one sets for each main shaft);
K) Two numbers parallel key 14;
L) One set actuator consisting of parts 15, 16, 17;
M) One set extension of the friction surface of the endless belt with the main movable sets consisting of parts 18, 19, (not shown);
N) Two numbers shaft 20, (not shown);
O) One number endless Flat Belt 22, (not shown);
P) One set actuator, Part 15 of actuator set (15,16,17) are Connected to two parts 13 from two cylindrical slider sets 11,12,13 that they are placed on the input shaft 2 and on the output shaft 21, in which case two parts 13 and a part 15 become Seamlessly (one part), by moving forward or backward of part 15 by means of a hydraulic jack or as far as possible (electrical, mechanical, etc.), both cylindrical slider sets (11,12,13) move forward or backward. By inserting an endless flat belt on the main movable sets 6 on the both shafts 2 and 21, the mechanism is completed and the power transfer from the input shaft 2 to the output shaft 21 through the endless flat belt;
Q) One number sun gear set consisting of carrier 26, planetary gears 27, ring gear 28, sun gear 29, carrier 26 is placed and fixed on the input shaft 2, ring gear 28 placed on the carrier 26 and the ring gear has free rotation on the Carrier;
R) Sun gear 29 placed and fixed on the output shaft 30;
S) Three numbers interface gear (22,23, 24) and shaft 25, the gear 22 is placed and fixed on the secondary shaft 21, the gear 24 is placed and fixed on the ring gear 28, the shaft 25 is fixed on the body 1, the gear 23 is placed on the shaft 25, the gear 25 has free rotation on the shaft 25 and the gear 23 involved with two gears (22, 24).

FIG. 15 configuration of mechanism and components includes:
A) One number main body 1;
B) Three numbers shaft, power input shaft 2, and secondary shaft 21;
C) Forty-eight numbers main guide rod 3, (Twenty-four numbers for each main shaft);
D) Forty-eight numbers secondary guide rod 4, (Twenty-four numbers for each main shaft);
E) Twenty-four sets secondary movable 5 consisting of parts 51,52, (Twelve sets for each main shaft);
F) Twenty-four sets main movable 6 consisting of parts 61, 62, 63, (Twelve sets for each main shaft);
G) Four numbers guide disk 7, (Two guide disks for each main shaft);
H) Four numbers shaft 8 for coupling disks (two shafts for coupling two disks);
I) Four sets of interfaces consisting of parts 9, 10, (two sets for each main shaft);
J) Two sets of cylindrical sliders that consisting of parts 11, 12, 13, (one sets for each main shaft);
K) Two numbers parallel key 14;
L) One set actuator consisting of parts 15, 16, 17;
M) One set extension of the friction surface of the endless belt with the main movable sets consisting of parts 18, 19, (not shown);
N) Two numbers shaft 20, (not shown);
O) One number endless Flat Belt 22, (not shown);
P) One set actuator, Part 15 of actuator set (15,16,17) are Connected to two parts 13 from two cylindrical slider sets 11,12,13 that they are placed on the input shaft 2 and on the output shaft 21, in which case two parts 13 and a part 15 become Seamlessly (one part), by moving forward or backward of part 15 by means of a hydraulic jack or as far as possible (electrical, mechanical, etc.), both cylindrical slider sets (11,12,13) move forward or backward. By inserting an endless flat belt on the main movable sets 6 on the both shafts 2 and 21, the mechanism is completed and the power transfer from the input shaft 2 to the output shaft 21 through the endless flat belt;
Q) One number sun gear set consisting of carrier 26, planetary gears 27, ring gear 28, sun gear 29, carrier 26 is placed and fixed on the input shaft 2, ring gear 28 placed on the carrier 26 and the ring gear has free rotation on the Carrier;
R) Sun gear 29 placed and fixed on the output shaft 30;
S) Three numbers interface gear (22,23, 24) and shaft 25, the gear 22 is placed and fixed on the secondary shaft 21, the gear 24 is placed and fixed on the ring gear 28, the shaft 25 is fixed on the body 1, the gear 23 is placed on the shaft 25, the gear 25 has free rotation on the shaft 25 and the gear 23 involved with two gears (22, 24).

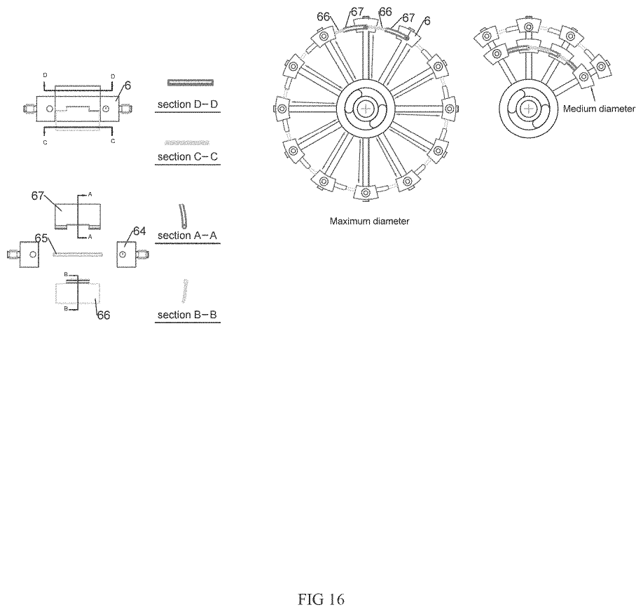

FIG. 16 another type of main movable set 60 is shown and is composed of:
A) two parts 64 each having a hole with a diameter equal to the diameter of the main guide rods 3 (with a further tolerance), and also a small shaft mounted on one said of each part 64, each of these small shafts placed in the curve groove of the guide disks;
B) a shaft 65 that is arranged between two parts 64 and fixes two parts 64 so that the axial distance of the two holes of two parts 64 is equal to the axial distance of the two main guide rods 3 that they are installed on the input shaft; and
C) two parts of cover plate 66 and 67, As shown in the figure, the part 66 is (male) (section C-C) and the part 67 is empty inside (female) (section D-D). And as seen they are free on the shaft 65, the outside shape of the two parts 66, 67 is an arc of the circle. The part 66 of the main movable set 60 is placed inside the part 67 from the adjacent main movable set 60. During the move of the main movable sets 60 on the main guide rods 3, The part 66 will has slider movement whit adjacent part 67.

and also illustrate the main movable sets 60 on the main guide rods 3 in the maximum diameter and also in the middle diameter. By using this type of main movable sets 60, the second control mechanism will be eliminated from two main shaft sets (input and output).

It means from each main shafts (input and secondary shafts), twelve pairs of secondary guide rods 4, as well as twenty-four numbers holes on each shaft and twelve sets secondary movable 5, as well as twelve numbers curve grooves (second kind) on the guide disks are eliminated (only twelve numbers curve grooves are required to control the main movable sets 60 on each guide disks).

Because the main movable sets 6 are controlled by two non-parallel guides (the main guide rods 3 and disks curve grooves 7), and because the main guide rods 3 are in line with the radii of the shaft 2 and they are also arranged by equal degrees (thirty degrees), as well as the regularity and uniformity of the curve grooves on the guide disks 7.

If a pair guide disks 7 on the input shaft 2 do not rotate relative to the shaft 2, the main movable sets 6 will be in steady state on the main guide rods 3 and all of them have equal distance from the axis of the shaft 2 and created a specified diameter.

By rotating the pair guide disk 7 relative to the shaft 2, the main movable sets 6 changes location on the main guide rods 3 and along rods axis (in line with the radii of the input shaft), and value of this change in location on the main guide rods 3 are equal in all of the main movable sets 6 and always all of the main movable sets 6 distance from the center of the shaft 2 are the same.

Meaning that by rotating the guide disk 7 relative to the shaft 2 the diameter of the input shaft 2 will be changed, as well as secondary movable sets 5 change location on the secondary guide rods 4 and along rods axis (in line with the radii of the input shaft), and value of this change location are equal in all of the secondary movable sets 5 and always all of the secondary movable sets distance from the center of the shaft 2 is the same.

The cylindrical slider set 11, 12, 13 can have linear motion on the shaft 2 and along its axis. The bearing 12 between the cylindrical slider 11 and the retainer part 13 of the cylindrical slider set 11, 12, 13 causes the retainer part 13 does not following the rotation movement of the cylindrical slider part 11, and also by the parallel key 14 between the cylindrical slider part 11 and the input shaft 2, the rotational movement of cylindrical slider part 11 is the same with the rotational movement of the shaft 2.

As described in the FIGS. 10 and 11, one pair guide disk of each shaft sets (input 2 and secondary shaft 21) is coupled together by two shaft 8, so rotational movement of two guide disks will be same, shaft 10 is connected to the part 9, part 9 is connected to the guide disk 7, two shafts 10 are placed into two helical grooves on outer surface of the cylindrical slider 11.

When the cylindrical slider 11 has linear motion along the axis of the input shaft 2, parts 10, 9 and pair guide disk 7 have rotational movement relative to the cylindrical slider 11 and also input shaft 2.

By rotational movement of pair guide disk 7, all of main movable sets 6 and secondary movable sets 5, Change location on the main guide rods 3 and secondary guide rods 4, as a result, the variable diameter of the input shaft 2 will change.

As explained above, all parts and sets mounted on the input shaft 2 and the secondary shaft 21 are same (other than the curve grooves direction of corresponding pairs disk at the two input 2 and secondary shaft 21 are inverse to one another).

In this mechanism, when actuator 16 move part 15 (forward or backward), two cylindrical slider sets (11, 12, 13) will have linear motion on the two shaft 2 and shaft 21 and the two pair guide disks 7 have rotational motion relative to his shaft 2 and shaft 21 and change location of all main movable sets 6 on the main guide rods 3 and secondary movable sets 5 on the secondary guide rods 4, as a result, the variable diameters of shaft 2 and shaft 21 will change.

Because the curve grooves direction of a pair guide disk 7 that placed on the shaft 2 are inverted with curve grooves direction of a pair guide disks 7 that placed on the shaft 21, so the diameters variations of the input shaft 2 and the secondary shaft 21 will be inverted, that means when the diameter of the one shaft increases, the diameter of the other shaft will decrease.

An endless flat belt 22 (made of metal or rigid metal or) on the assembly of variable diameter on both shafts 2 and 21 and therefore the power transfer (torque-rotation) from the input shaft 2 to the secondary shaft 21 is carried out through the flat belt.

Because movement of actuator 16 is continuous movement, so the movement of the part 15 and the associated two cylindrical slider sets (11, 12, 13) will be continuous. as a result, the rotation motion of the two pairs guide disk 7 will be continuous, and finally the diameters variations of the input shaft 2 and secondary shaft 21 will be continuous. And with continuous of the diameter's variation, the conversion ratios of the input shaft 2 and secondary shaft 21 also will be continuous.

In Table 1, N is the rotation speed of the shafts, D is variable diameter of shafts. An index shows the component number. For example, N₂ is the rotation speed of shaft 2 and D₂ is variable diameter of shaft 2. N₂₁ is the rotation speed of shaft 21 and D₂₁ is variable diameter of shaft 21.

TABLE 1

| | |
|---|---|
| 1) | N₂ × D₂ = N₂₁ × D₂₁ |
| 2) | N₂₁/N₂ = D₂/D₂₁ |
| 3) | D₂/D₂₁ = X |
| 4) | N₂₁ = X × N₂ |
| 5) | X = N₂₁/N₂ |

As explained above, the carrier 26 fixed on the input shaft 2 and sun gear 29 fixed on the output shaft 30, and secondary shaft 21 involved with the ring gear 28 (can be gears, chain with gear and etc.), for example, by three gears (22, 23, 24), as a result, by changing the speed of the secondary shaft 21 rotation, the rotational speed of the output shaft 30 will also change. Because changing the speed of the secondary shaft 21 rotation is continuous, so, changes the rotational speed of the output shaft 30 will also continuous.

In Table 2, N₂₆ is rotational speed of carrier that equal with rotational speed of output shaft 2, that is mean N₂, N₂₇ is rotational speed of ring gear and G₂₇ is teeth number of ring gear, N₂₈ is rotational speed of sun gear and G₂₈ is teeth number of sun gear, N₃₀ is rotational speed of sun gear 29 or output shaft 30, R is the conversion rate in the mechanism.

TABLE 2

| | |
|---|---|
| 1) | N₂ = N₂₆ = (G₂₉ × N₂₉ + G₂₈ × N₂₈)/(G₂₉ + G₂₈) = |
| | (G₂₉ × N₃₀ + G₂₈ × N₂₈)/(G₂₉ + G₂₈) |
| 2) | N₂₁= X × N₂ from table 1 |
| 3) | N₂₈/N₂₁= Υ |
| 4) | N₂₈ = Y × X × N₂ |
| 5) | N₂= (G₂₉ × N₃₀ + G₂₈ × Y × X × N₂)/(G₂₉ + G₂₈) |
| 6) | R = N₃₀/N₂ = (G₂₉ + G₂₈ − G₂₈ × X × Y)/G₂₉ |
| 7) | For example, G₂₈ = 100, G₂₉ = 40, Y = 1, |
| 8) | R = (140 − 100 × X)/40 |

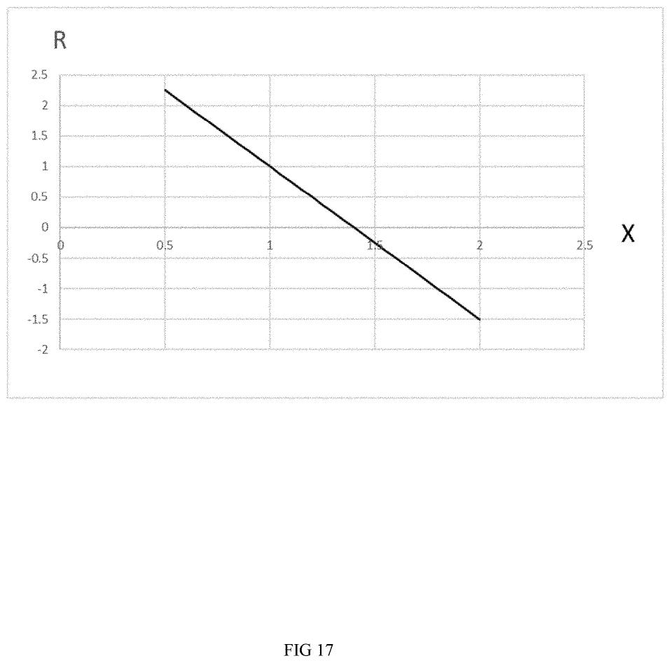

In the FIG. 17, the value changes of R to the value changes of X, shows in curved form. As can be seen, the value of R can be negative, zero and positive. Therefore, in this mechanism the output shaft can be stopped without the clutch while the input shaft is rotating, this means that no clutch is used in this mechanism.

The strap stiffening set shown in FIG. 13 increases the belt contact surface with the environmental level of the assembly of variable diameters and thus increases the efficiency of the mechanism.

By installing the number of sensors on the mechanism and controlling the actuator through the sensors, this invention will be automatic.

Because the parts used in this invention are simple, therefor, production of this mechanism with the simple facilities is possible.

This invention useable in all industries that need to be converted the rotation speed to the torque, including, automotive, shipbuilding, machine tools.

The separation of various system components in the examples described above should not be understood as requiring such separation in all examples, and it should be understood that the described components and systems can generally be integrated together in a single packaged into multiple systems.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus the following claims are hereby incorporated into the Detailed Description, with each claim standing on its own as a separately claimed subject matter.

What is claimed is:

1. The Variable Diameter shaft (VDS·CVT) is a mechanism for converting torque to rotation speed, without limitation in the amount of torque transfer value. This mechanism consists of one set variable diameter input shaft and one set variable diameter secondary shaft and an endless flat belt between the two input and secondary shaft sets for transferring power between the two shaft sets and one set actuator and one set of sun gear and interface components for transfer between secondary shaft and a components of sun gear set, and a friction augmentation set and number of sensors, In this mechanism, with stimulation the actuator which is connected to the two cylindrical slider sets, caused the continuous liner motion of the two cylindrical slider sets on the shafts (input and secondary), and this continuous linear motion of the two cylindrical slider set caused the continuous rotating motion of the guide disks relative to the their shafts(input and secondary). And this rotating motion of the guide disks caused the continuous changes of the main and secondary movable set with their cover plats (environmental movable sets), which are located on the main and secondary guide rods. And this location change in the main and secondary movable sets caused the continuous change in the diameter sizes of the input and secondary shaft sets (the diameter size variations in two input shaft and secondary shafts are inverse). Finally by continuous change in the diameter sizes of the input and secondary shaft sets, the ratio of the rotational speed of the secondary shaft to the input shaft changes continuously. By connecting the secondary shaft with one components of sun gear set via interface components (gears, chain, etc. . . . ), and by direct connecting the input shaft with the second components of sun gear set, and the third components of sun gear set connected with the output shaft. The continuously changes of secondary shaft transfer to component of sun gear set, as result, the continuously rotational speed transfer to output shaft.

2. The VDS·CVT of claim 1, wherein an input shaft set comprising of:
a number of holes (in two sizes) are formed on its lateral surface;
a number of main guide rods;
a number of secondary guide rods;
a number of main movable sets with cover plates;
a number of secondary movable sets;
two guide disks;
two sets interfaces;
two small shafts for coupling two guide disks; and
a set cylindrical guide slider.
The VDS·CVT of claim 1, wherein a secondary shaft set comprising of:
a secondary shaft that has mounted a parallel keys on it and a number of holes (in two sizes) are formed on its lateral surface;
a number of main guide rods that those attaches in holes on the secondary shaft;
a number of secondary guide rods;
a number of main movable sets with cover plates that each main movable set is placed on a pair of main guide rods;
a number of secondary movable sets;
two guide disks that placed on the;
two sets interfaces;
two small shafts for coupling two guide disks; and
a set cylindrical guide slider.

3. The VDS·CVT of claim 1, wherein a secondary shaft set comprising of:
a secondary shaft that has mounted a parallel keys on it and a number of holes (in two sizes) are formed on its lateral surface;
a number of main guide rods that those attaches in holes on the secondary shaft;
a number of secondary guide rods;
a number of main movable sets with cover plates that each main movable set is placed on a pair of main guide rods;
a number of secondary movable sets;
two guide disks that placed on the shaft;
two small shafts for coupling two guide disks; and
a set cylindrical guide slider.

4. The VDS·CVT of claim 1-4, wherein the main guide rods are mounted inside the holes (in the first type) on the lateral surface of the main shafts.

5. The VDS·CVT of claim 1-4, wherein the secondary guide rods are mounted inside the holes (in the second type) on the lateral surface of the main shafts.

6. The VDS·CVT of claim 1-4, wherein the number of main movable sets are equal to half the number of the main guide rods, and a number of cover plates placed on its axis and mounted a small shaft on each end of main parts, and each of the main movable sets placed on a pair of main guide rods and can linear motion along the axis of the guide rods and each main movable set includes two main parts:

7. The VDS·CVT of claim 1-4, wherein two guide disks, has been created a number of tow kind curve grooves (or linear) on the surface of each guide disks, and the number of each kind (first kind and second kind) of grooves are equal with the number of main movable sets or number of secondary movable sets, direction of curve groove on the surfaces of pair disks that placed on the input and secondary shafts, they are symmetrical and when assembled they will have the same direction of grooves, Has been created a hole at the center of each of the disks and also two other holes at the specified points for coupling two guide disks to each other and four holes for mounted two interface sets (a disk of each disk pair).

8. The VDS·CVT of claim 4, wherein two sets of interfaces mounted on a disk of a pair guide disk. the interface sets convert liner motion of cylindrical guide slider to rotational motion of pair guide disk and each interface set includes:
an interface part; and
a small shaft.

9. The VDS·CVT of claim 1-4, each cylindrical guide slider set includes:
a cylindrical guide slider part;
a ball bearing; and
a retainer part.

10. The VDS·CVT of claim 1-11, wherein the cylindrical guide slider part has an inner hole in direction of the cylindrical axis and has one groove in side surface of the hole in direction of the hole axis and also has two helical and symmetrical guide grooves on the outer surface.

11. The VDS·CVT of claim 10-12, wherein the two small shafts from the two sets of interfaces are placed into the two helical and symmetrical guide grooves in cylindrical guide slider part and converts the linear motion of the cylindrical slider part to the rotating motion on the pair guide disk.

12. The VDS·CVT of claim 1, wherein an actuator set to create a linear motion in the two cylindrical slider sets which are placed on the input and secondary shafts, that include:
an actuator;
an interface plate that is connected to the actuator and two retaining parts of the two cylindrical slider sets; and
two guide shafts for interface plate.

13. The VDS·CVT of claim 1, wherein a friction augmentation set to increase the surface of friction between endless flat belt and main movable sets, that include:
a retaining structure;
two guide shafts for retaining structures; and
eight free wheels mounted on retaining structures.

14. The VDS·CVT of claim 1, wherein an endless flat belt (made of metal or rigid metal or . . . ) on the assembly of variable diameter on both input and output shaft sets and therefore the power transfer (torque-rotation) from the input shaft to the secondary shaft is carried out through the endless flat belt.

15. The VDS·CVT of claim 1, wherein one set of sun gear, that include:
a sun gear;
a ring gear; and
a carrier.

16. The VDS·CVT of claim 1, wherein interface components (gears, chain, etc. . . . ).

17. The VDS·CVT of claim 1, wherein one output shaft.

18. The VDS·CVT of claim 1, wherein a number of sensors for automating the mechanism.
